(19) United States
(12) Patent Application Publication
(10) Pub. No.: US 2017/0241772 A1
(43) Pub. Date: Aug. 24, 2017

(54) PHASE-ERROR COMPENSATION METHOD AND DEVICE

(71) Applicant: SHENZHEN UNIVERSITY, Shenzhen (CN)

(72) Inventors: Xiang PENG, Shenzhen (CN); Zewei CAI, Shenzhen (CN); Xiaoli LIU, Shenzhen (CN); Wenqi HE, Shenzhen (CN); Hao JIANG, Shenzhen (CN)

(21) Appl. No.: 15/125,505

(22) PCT Filed: Sep. 2, 2015
(86) PCT No.: PCT/CN2015/088878

§ 371 Date: Sep. 12, 2016

(51) Int. Cl. G01B 11/24

(52) U.S. Cl. CPC G01B 11/24

(57) ABSTRACT

A phase-error compensation method and device, comprising: utilizing a phase-shifting-profilometry measuring system to obtain fringe sequence charts; based on Hilbert transform, transforming the fringe sequence charts from a space domain to a Hilbert transform domain; based on least squares phase shift method, solving the phases of the fringe sequence charts in the space domain and the Hilbert transform domain respectively, and obtaining a phase chart in the space domain and a phase chart in the Hilbert transform domain; averaging the phase chart in the space domain and the phase chart in the Hilbert transform domain to obtain an average phase, and utilizing the average phase to perform phase-error compensation. The invention possesses a self-compensation mechanism, does not need any auxiliary condition, and thus meets the requirements of high-speed, high-precision and high-universality 3D digital imaging and measuring based on the phase shifting profilometry.

### FIELD OF THE INVENTION

The present application belongs to the technical field of optical 3D digital imaging, especially to a phase-error compensation method and device.

### BACKGROUND OF THE INVENTION

Phase shifting profilometry is a contactless, full-field measured optical 3D digital imaging and measuring method. The method utilizes a projection-collection device to obtain a set of fringe sequence charts which have been adjusted according to an object surface shape, and utilizes phase-shifting algorithm to calculate the phase of an effective measuring point; the phase is then used to calculate 3D surface information of the object. The phase shifting profilometry has been widely used because of its characteristics such as high imaging density, high imaging speed, high measuring accuracy and high measuring universality, etc.

With rapid development of digital projecting and imaging technology, programmable digital fringe projecting phase shifting profilometry has occurred. Compared with traditional grating projection, an advantage of digital fringe projection is that it utilizes a computer to generate grating fringes, and utilizes a digitized projecting device as a transmitted light source, such that grating fringes with any shape and frequency can be conveniently projected, accurate phase shifting can be achieved, and phase shifting errors can be eliminated. However, problems of non-linear intensity responses between inputs and outputs may occur in the process of obtaining digitized projection-collection signals, for example, a sinusoidal input signal may be responded as a non-sinusoidal output signal; thus, a phase measuring error may be introduced and finally affect accuracy of 3D reconstruction.

The above non-linear intensity response is generally referred to as gamma effect. In order to reduce the measuring error caused by the gamma effect, the prior art provides methods for phase-error compensation or gamma correction. Typical methods include: 1. obtaining responses of the projection-collection device to a series of grey levels, and fitting a system response characteristic curve; 2. creating a phase-error compensation lookup table of a specific step phase-shifting algorithm based on experimental statistical data; 3. creating a phase error model using the specific step phase-shifting algorithm, solving a system gamma coefficient for inhibiting the gamma effect; 4. utilizing a defocus technology of optical system to project a binary fringe pattern and the like.

However, the phase-error compensation method for the phase shifting profilometry provided by the prior art requires additional auxiliary conditions, such as calibration to the response curve, gamma coefficient and reference phase, or optical defocus, and thus is prone to be disturbed by measuring conditions or requires manual assistant operations, such that the accuracy of the 3D reconstruction may be affected.

### SUMMARY OF THE INVENTION

The purpose of embodiments of the invention is to provide a phase-error compensation method and device, which aim to solve the problem that a currently existing phase-error compensation method requires relying on additional auxiliary conditions, is prone to be disturbed by measuring conditions, or requires manual auxiliary operations, thereby leading to effect on the accuracy of 3D reconstruction.

An embodiment of the invention is accomplished as follows: a phase-error compensation method, comprising:

utilizing a phase-shifting-profilometry measuring system to obtain fringe sequence charts;

based on Hilbert transform, transforming the fringe sequence chart from a space domain to a Hilbert transform domain;

based on the least squares phase shift method, solving the phases of the fringe sequence charts in the space domain and in the Hilbert transform domain respectively, and obtaining a phase chart in the space domain and a phase chart in the Hilbert transform domain;

averaging the phase chart in the space domain and the phase chart in Hilbert transform the domain to obtain an average phase, and utilizing the average phase to perform phase-error compensation.

Another purpose of embodiments of the invention is to provide a phase-error compensation device, comprising:

an obtaining unit configured to utilize a phase-shifting-profilometry measuring system to obtain fringe sequence charts;

a transforming unit configured to transform the fringe sequence charts from a space domain to a Hilbert transform domain based on Hilbert transform;

a solving unit configured to solve the phases of the fringe sequence charts in the space domain and the Hilbert transform domain respectively based on least squares phase shift method, and obtain a phase chart in the space domain and a phase chart in the Hilbert transform domain;

a phase-error compensating unit configured to average the phase chart in the space domain and the phase chart in the Hilbert transform domain to obtain an average phase, and utilize the average phase to perform phase-error compensation.

The embodiment of the invention provides a phase-error distribution model in the Hilbert transform domain, and compares the model with a model in space domain; and according to the distribution feature of phase errors in the two domains, and further based on analysis to the feature, provides a phase-error compensation method based on Hilbert transform. The method possesses a self-compensation mechanism, does not need any auxiliary condition, and thus meets the requirements of high-speed, high-precision and high-universality 3D digital imaging and measuring based on the phase shifting profilometry.

### BRIEF DESCRIPTION OF THE DRAWINGS

In order to explain the technical solutions of the embodiments of the present invention more clearly, drawings required being used in the descriptions of the embodiments and the prior art are briefly introduced as follows. Obviously, the drawings described as follows are merely some embodiments of the present invention. Those skilled in the art can obtain other drawings on the basis of these drawings without paying any creative work.

FIG. 1 is an implementation flow chart of a phase-error compensation method provided by an embodiment of the invention;

FIG. 2 is a curve chart of phase error distribution drawn through simulated data provided by an embodiment of the invention;

FIG. 3 is a phase-error distribution chart obtained by performing phase measurement for a whiteboard provided by an embodiment of the invention;

FIG. 4, from left to right, illustrates a 3D digital model of a plaster model obtained before performing a phase-error compensation in the space domain, a 3D digital model of the plaster model obtained before performing a phase-error compensation in the Hilbert transform domain, and a 3D digital model of the plaster model obtained after performing a phase-error compensation using the method provided by an embodiment of the invention, respectively; and

FIG. 5 is a structural block diagram of a phase-error compensation device provided by an embodiment of the invention.

### DETAILED DESCRIPTION OF THE PREFERRED EMBODIMENT

In order to explain the technical solutions of the invention, the invention is described hereinafter with reference to specific embodiments. The following description, for illustration but not limitation, provides specific details such as specific system organization and techniques so as to understand embodiments of the invention more thoroughly. However, it should be clear for those skilled in the art that other embodiments without these specific details still can realize the invention. In other cases, detailed descriptions for well-known systems, devices, circuits and methods can be omitted, so that unnecessary details are prevented from impeding the description for the invention.

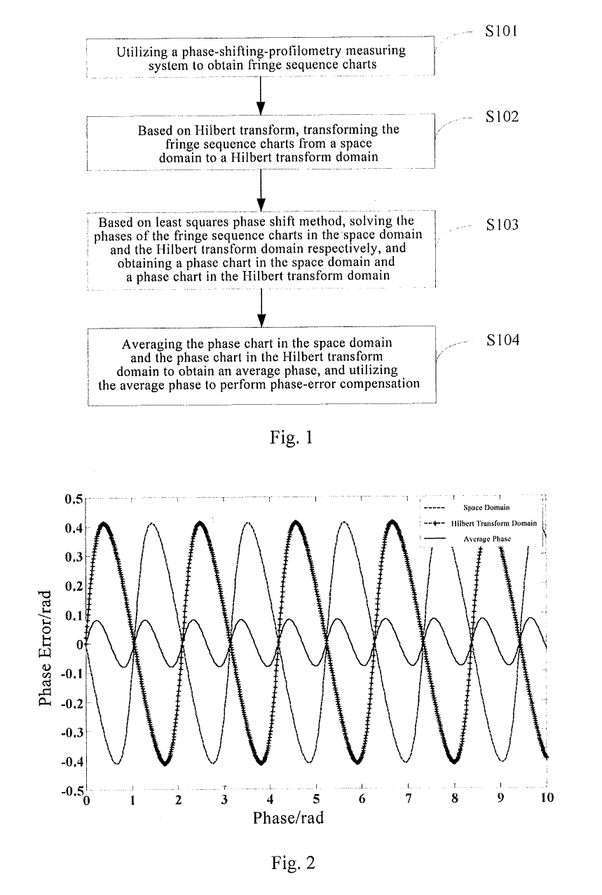

FIG. 1 illustrates an implementation process of a phase-error compensation method provided by an embodiment of the invention. The process is detailed as follows:

Step 101. utilizing a phase-shifting-profilometry measuring system to obtain fringe sequence charts.

At first, utilizing the phase-shifting-profilometry measuring system to obtain a group of three-step phase-shifting fringe sequence charts, which are fringe sequence charts in a space domain. Since in the phase-shifting-profilometry measuring system, there exists non-linear intensity responses in a real projection-collection device, the output signal of the phase-shifting-profilometry measuring system will introduce high-efficiency harmonic due to gamma effect. Therefore, the fringe sequence charts obtained in step 101 are expressed as follows:

$${I}_{n}^{C} = {[ A + B cos ( φ + {δ}_{n} ) ]}^{γ} = {B}_{0} + {\sum }_{k = 1}^{∞} [ {B}_{k} cos ( k {φ}_{n} ) ]$$

Wherein, Iₙ^{C} represents the intensity of the n-th phase-shifting chart in the fringe sequence output by the phase-shifting-profilometry measuring system; A represents the background intensity of the fringe; B represents the adjusted intensity of the fringe; φ represents the actual phase adjusted by the surface to be measured, wherein the actual phase contains depth information of the surface to be measured; B₀ represents a DC component; Bₖ represents the intensity of a k-order harmonic; δₙ=2π(n−1)/N represents the phase-shifting amount of the n-th phase-shifting chart; N represents the number of phase-shifting steps of the phase-shifting profilometry utilized by the phase-shifting-profilometry measuring system; φₙ=φ+δₙ represents the adjusted phase-shifting phase; γ represents the gamma coefficient of the phase-shifting-profilometry measuring system, and is a representation of the non-linear effect of the system.

Step 102. Based on Hilbert transform, transforming the fringe sequence charts from the space domain to a Hilbert transform domain.

Specifically, the phase-shifting fringe sequence charts are transformed from the space domain into the Hilbert transform domain according to the equation

$${I}_{n}^{HC} = H ( {I}_{n}^{C} ) = - {\sum }_{k = 1}^{∞} [ {B}_{k} sin ( k {φ}_{n} ) ] ,$$

wherein H(g) represents Hilbert transform; Iₙ^{HC} represents the intensity of the n-th phase-shifting chart in the fringe sequence output by the phase-shifting-profilometry measuring system after the transformation. Herein, through the Hilbert transform, a phase shift of π/2 is introduced, and the DC component is filtered out.

Step 103. Based on the least squares phase shift method, solving the phases of the fringe sequence charts in the space domain and in the Hilbert transform domain respectively, and obtaining a phase chart in the space domain and a phase chart in the Hilbert transform domain.

Specifically:

Utilizing the equation

$${φ}^{C} = arctan [ \frac{- {\sum }_{n = 1}^{N} ( {I}_{n}^{C} sin {δ}_{n} )}{{\sum }_{n = 1}^{N} ( {I}_{n}^{C} cos {δ}_{n} )} ]$$

to solve the phase of the fringe sequence charts in the space domain;

Utilizing the equation

$${φ}^{HC} = arctan [ \frac{{\sum }_{n = 1}^{N} ( {I}_{n}^{HC} cos {δ}_{n} )}{{\sum }_{n = 1}^{N} ( {I}_{n}^{HC} sin {δ}_{n} )} ]$$

to solve the phase of the fringe sequence charts in the Hilbert transform domain; wherein, φ^{C} is the phase obtained by solving the fringe sequence charts in the space domain; φ^{HC} is the phase obtained by solving the fringe sequence charts in the Hilbert transform domain.

Step 104. Averaging the phase chart in the space domain and the phase chart in the Hilbert transform domain to obtain an average phase, and utilizing the average phase to perform phase-error compensation.

Specifically, since the gamma effect introduces the phase error, there is a difference between the actually solved phase and the real phase φ. In the Hilbert transform domain, the phase error distribution Δφ^{H} introduced by gamma effect can be derived as equation (1):

$$\begin{matrix}{Δφ}^{H} = {φ}^{HC} - φ \\ = arctan \{ \frac{\begin{matrix}cos φ {\sum }_{n = 1}^{N} {\sum }_{k = 1}^{∞} [ {B}_{k} sin ( k {φ}_{n} ) cos {δ}_{n} ] - \\ sin φ {\sum }_{n = 1}^{N} {\sum }_{k = 1}^{∞} [ {B}_{k} sin ( k {φ}_{n} ) sin {δ}_{n} ]\end{matrix}}{\begin{matrix}cos φ {\sum }_{n = 1}^{N} {\sum }_{k = 1}^{∞} [ {B}_{k} sin ( k {φ}_{n} ) sin {δ}_{n} ] + \\ sin φ {\sum }_{n = 1}^{N} {\sum }_{k = 1}^{∞} [ {B}_{k} cos ( k {φ}_{n} ) cos {δ}_{n} ]\end{matrix}} \} \\ = arctan \{ \frac{{\sum }_{n = 1}^{N} {\sum }_{k = 1}^{∞} [ {B}_{k} sin ( k {φ}_{n} ) cos {φ}_{n} ]}{{\sum }_{n = 1}^{N} {\sum }_{k = 1}^{∞} [ {B}_{k} sin ( k {φ}_{n} ) sin {φ}_{n} ]} \} \\ = arctan \{ \frac{{\sum }_{n = 1}^{N} {\sum }_{k = 2}^{∞} [ ( {B}_{k + 1} + {B}_{k - 1} ) sin ( k {φ}_{n} ) ]}{{NB}_{1} + {\sum }_{n = 1}^{N} {\sum }_{k = 2}^{∞} [ ( {B}_{k + 1} - {B}_{k - 1} ) cos ( k {φ}_{n} ) ]} \} \\ = arctan \{ \frac{{\sum }_{m = 1}^{∞} [ ( {G}_{mN + 1} + {G}_{mN - 1} ) sin ( mN φ ) ]}{1 + {\sum }_{m = 1}^{∞} [ ( {G}_{mN + 1} - {G}_{mN - 1} ) cos ( mN φ ) ]} \}\end{matrix}$$

Wherein,

$${G}_{s} = \frac{{B}_{s}}{{B}_{1}} = {\prod }_{i = 2}^{s} \frac{γ - i + 1}{γ + i} .$$

Gₛ decreases significantly along with the increase of the harmonic order s, therefore, only considering N order harmonics is sufficient, and the influence of G_{N+1} on the phase error is significantly smaller than the influence of G_{N-1} on the phase error, thus, the equation (1) can be simplified into equation (2):

$${Δφ}^{H} = arctan [ \frac{{G}_{N - 1} sin ( N φ )}{1 - {G}_{N - 1} cos ( N φ )} ]$$

Equation (2) is a phase-error distribution model in the Hilbert transform domain. A phase-error distribution model in the space domain is as equation (3):

$$Δφ = arctan [ \frac{- {G}_{N - 1} sin ( N φ )}{1 + {G}_{N - 1} cos ( N φ )} ]$$

Based on analysis on the equations (2) and (3), the phase error between the space domain and the Hilbert transform domain is a periodic distribution relevant to the actual phase φ, the number of phase steps N and the gamma coefficient γ, and the periods thereof are all T=2π/N. Assuming that ∂Δφ^{H}/∂φ=0, amplitude A_{Δφ}^{H} of the phase error distribution in the Hilbert transform domain, which is also the maximum phase error |Δφ^{H}|ₘₐₓ, can be obtained and expressed in equation (4):

A_{Δφ}^{H}=|Δφ^{H}|ₘₐₓ=arcsin(|G_{N-1}|)

Similarly, assuming that ∂Δφ/∂φ=0, an amplitude A_{Δφ} of the phase error distribution in the space domain, which is also the maximum phase error |Δφ|ₘₐₓ, max can be obtained and expressed in equation (5):

A_{Δφ}=|Δφ|ₘₐₓ=arcsin(|G_{N-1}|)

Furthermore, between the equations (1) and (2) there exists a relationship as expressed by equation (6):

$${Δφ}^{H} {\vert}_{φ + \frac{T}{2}} = arctan \{ \frac{{G}_{N - 1} sin [ N ( φ + \frac{π}{N} ) ]}{1 - {G}_{N - 1} cos [ N ( φ + \frac{π}{N} ) ]} \} = arctan [ \frac{- {G}_{N - 1} sin ( N φ )}{1 + {G}_{N - 1} cos ( N φ )} ] = Δφ {\vert}_{φ} \qquad$$

Therefore, the characteristics of the phase error distributions in the space domain and in the Hilbert transform domain can be summarized as follows:

1. having an identical period of T=2π/N;

2. having an identical amplitude of A=arcsin(|G_{N-1}|), as expressed by equations (4) and (5);

3. having a distribution phase difference of half a period as expressed by equation (6), thereby making the distributions of the phase errors in the space domain and in the Hilbert transform domain present reversed trends.

In step 104, the phase chart in space domain and the phase chart in Hilbert transform domain are averaged, specifically:

the phase chart in the space domain and the phase chart in the Hilbert transform domain are averaged according to φ^{M}=½(φ^{C}+φ^{HC}), wherein φ^{M} is an averaged phase obtained after the averaging step.

Furthermore, by combining equations (2) and (3), the phase error between the average phase and the real phase can be concluded as follows:

$${Δφ}^{M} = {φ}^{M} - φ = \frac{1}{2} ( Δφ + {Δφ}^{H} ) = \frac{1}{2} arctan [ \frac{{G}_{N - 1}^{2} sin ( 2 N φ )}{1 - {G}_{N - 1}^{2} cos ( 2 N φ )} ]$$

Assuming that ∂Δφ^{M}/∂φ=0, the maximal phase error of the average phase can be expressed by equation (7):

|Δφ^{M}|ₘₐₓ=½ arcsin(G_{N-1}²)

Based on the comparison between equations (7) and (5), since |G_{N-1}|<1, the average phase has compensated the phase error caused by the gamma effect.

FIG. 2 illustrates a curve chart of the phase error distribution drawn through simulated data (G_{N-1}=0.4, N=3), wherein the dash line represents the phase error distribution in the space domain, and the dot-dash line represents the phase error distribution in the Hilbert transform domain. It can be clearly seen that the phase errors in the two domains have approximately equal absolute values and reversed plus-minus signs. The solid line in FIG. 2 illustrates the phase error distribution of the average phase, compared with the phase errors in the space domain and the Hilbert transform domain, the compensated phase error is significantly decreased.

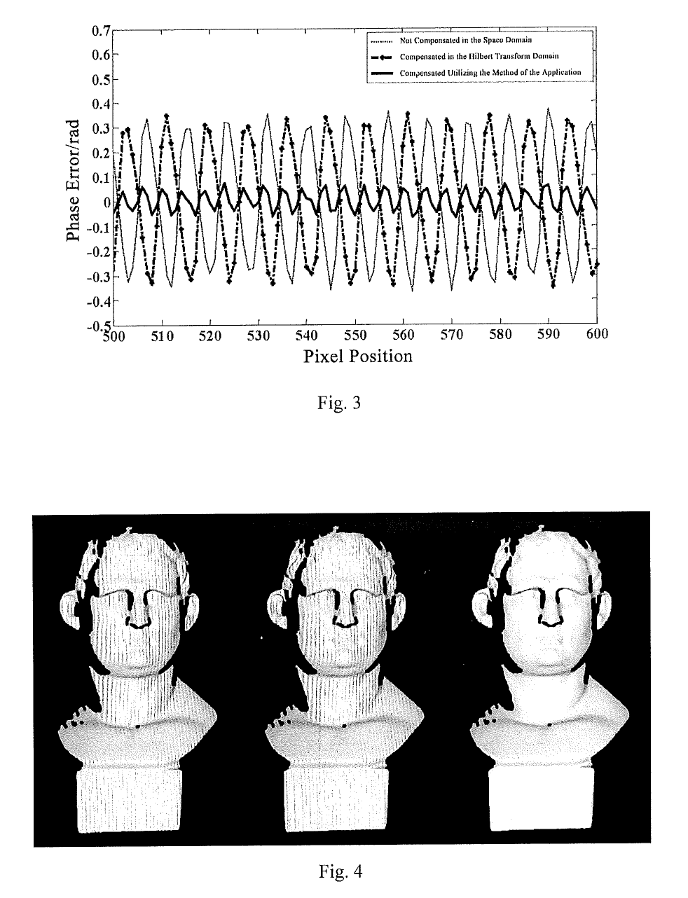

FIG. 3 is a phase error distribution obtained by performing a phase measurement for a whiteboard in an experiment, and only a line in the middle of a picture is shown. The dash line and the dot-dash line represent the phase error distributions in the space domain and the Hilbert transform domain before the compensation respectively; the solid line represents the phase error distribution compensated by the method of the invention. In consistence with that shown in FIG. 2, in the actual measurement, the phase error compensated by the method of the invention is significantly decreased too.

A left picture and a middle picture in FIG. 4 are respectively a 3D digital model of a plaster model obtained before the phase-error compensation in the space domain in an experiment and a 3D digital model of a plaster model obtained before the phase-error compensation in the Hilbert transform domain in an experiment; a right picture in FIG. 4 is a 3D digital model of the plaster model obtained after the phase-error compensation using the method of the invention in an experiment. As can be seen, after the phase-error compensation using the method of the invention, the accuracy of the 3D digital imaging is significantly improved.

The embodiment of the invention provides a phase-error distribution model in the Hilbert transform domain, and compares the model with a model in space domain; and according to the distribution feature of phase errors in the two domains, and further based on analysis to the feature, provides a phase-error compensation method based on Hilbert transform. The method possesses a self-compensation mechanism, does not need any auxiliary condition, and thus meets the requirements of high-speed, high-precision and high-universality 3D digital imaging and measuring based on the phase shifting profilometry.

It should be understood that the serial number of each step in this embodiment does not signify the execution sequence; the execution sequence of each step should be determined according to its function and internal logic, and should not form any limitation to the implementation process of the embodiment of the invention.

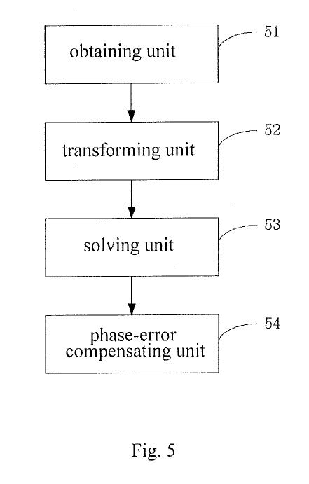

Corresponding to the phase-error compensation method in the above embodiment, FIG. 5 illustrates a structural block diagram of a phase-error compensation device provided by an embodiment of the invention; the phase-error compensation device can be a software unit, a hardware unit or a unit combining software into hardware. For clarity, only the portions relevant to the embodiment are illustrated.

Referring to FIG. 5, the device includes:

an obtaining unit 51 configured to utilize a phase-shifting-profilometry measuring system to obtain fringe sequence charts;

a transforming unit 52 configured to transform the fringe sequence charts from a space domain to a Hilbert transform domain based on Hilbert transform;

a solving unit 53 configured to solve the phases of the fringe sequence charts in the space domain and the Hilbert transform domain respectively based on least squares phase shift method, and obtain a phase chart in the space domain and a phase chart in the Hilbert transform domain;

a phase-error compensating unit 54 configured to average the phase chart in the space domain and the phase chart in the Hilbert transform domain to obtain an average phase, and utilize the average phase to perform phase-error compensation.

Optionally, the fringe sequence charts obtained by the obtaining unit 51 are expressed as follows:

$${I}_{n}^{C} = {[ A + B cos ( φ + {δ}_{n} ) ]}^{γ} = {B}_{0} + {\sum }_{k = 1}^{∞} [ {B}_{k} cos ( k {φ}_{n} ) ]$$

Wherein, Iₙ^{C} represents the intensity of the n-th phase-shifting chart in the fringe sequence output by the phase-shifting-profilometry measuring system; A represents the background intensity of the fringe; B represents the adjusted intensity of the fringe; φ represents the actual phase adjusted by the surface under test; B₀ represents a DC component; Bₖ represents the intensity of a k-order harmonic; δₙ=2π(n−1)/N represents phase-shifting amount of the n-th phase-shifting chart; N represents the number of phase-shifting steps of the phase-shifting profilometry utilized by the phase-shifting-profilometry measuring system; φₙ=φ+δₙ represents the adjusted phase-shifting phase; γ represents the gamma coefficient of the system, the γ is a representation of the non-linear effect of the system.

Optionally, the transforming unit 52 is specifically configured to:

transform the phase-shifting fringe sequence charts from space domain to Hilbert transform domain based on the equation

$${I}_{n}^{HC} = H ( {I}_{n}^{C} ) = - {\sum }_{k = 1}^{∞} [ {B}_{k} sin ( k {φ}_{n} ) ] ,$$

wherein H(g) represents Hilbert transform; Iₙ^{HC} represents the intensity of the n-th phase-shifting chart in the fringe sequence output by the phase-shifting-profilometry measuring system after the transformation.

Optionally, the solving unit 53 is specifically configured to:

utilize the equation

$${φ}^{C} = arctan [ \frac{- {\sum }_{n = 1}^{N} ( {I}_{n}^{C} sin {δ}_{n} )}{{\sum }_{n = 1}^{N} ( {I}_{n}^{C} cos {δ}_{n} )} ]$$

to solve the phase of the fringe sequence charts in space domain;

utilizing the equation

$${φ}^{HC} = arctan [ \frac{{\sum }_{n = 1}^{N} ( {I}_{n}^{HC} cos {δ}_{n} )}{{\sum }_{n = 1}^{N} ( {I}_{n}^{HC} sin {δ}_{n} )} ]$$

to solve the phase of the fringe sequence charts in Hilbert transform domain; wherein φ^{C} is the phase obtained by solving the fringe sequence charts in space domain; φ^{HC} is the phase obtained by solving the fringe sequence charts in Hilbert transform domain.

Optionally, the phase-error compensating unit 54 is specifically configured to:

average the phase chart in space domain and the phase chart in Hilbert transform domain utilizing φ^{M}=½(φ^{C}+φ^{HC}), wherein φ^{M} is an averaged phase after the averaging step.

Those skilled in the art can clearly understand that for convenient and clear description, the exemplary illustration is performed only according to the aforesaid classification for the functional units and modules. In practical applications, the above functions above can be assigned to be accomplished by different functional units and modules according to requirements, which means that inner structures of the device can be classified into different functional units or modules so as to accomplish all or some functions illustrated above. Each functional unit and module in the embodiments of the present invention can be integrated into a processing unit, or each unit can exist in isolation, or two or more than two units can be integrated into one unit. The integrated unit can be achieved in hardware or in software function unit. Furthermore, specific names of each functional unit and module are only intended to distinguish from each other, and are not intended to limit the protection scope of the application. The specific working process of the units and modules in the system can be referred to the corresponding process of the method embodiments, which is not further described herein.

Those skilled in the art should understand that the exemplary units and algorithm steps described in accompany with the embodiments disclosed in the specification can be achieved by electronic hardware, or the combination of computer software with electronic hardware. Whether these functions are executed in a hardware manner or a software manner depends on the specific applications and design constraint conditions of the technical solutions. With respect to each specific application, a professional technician can achieve the described functions utilizing different methods, and these achievements should not be deemed as going beyond the scope of the invention.

It should be understood that the systems, devices and methods disclosed in the embodiments provided by the present application can also be realized in other ways. For example, the described device embodiments are merely schematic; for example, the division of the units is merely a division based on logic function, whereas the units can be divided in other ways in actual realization; for example, a plurality of units or components can be grouped or integrated into another system, or some features can be omitted or not executed. Furthermore, the shown or discussed mutual coupling or direct coupling or communication connection can be achieved by indirect coupling or communication connection of some interfaces, devices or units in electric, mechanical or other ways.

The units described as isolated elements can be or not be separated physically; an element shown as a unit can be or not be physical unit, which means that the element can be located in one location or distributed at multiple network units. Some or all of the units can be selected according to actual needs to achieve the purpose of the schemes of the embodiments.

Furthermore, each functional unit in each embodiment of the present invention can be integrated into a processing unit, or each unit can exist in isolation, or two or more than two units can be integrated into one unit. The integrated unit can be achieved in hardware or in software function unit.

If the integrated unit is achieved in software functional unit and sold or used as an independent product, the integrated unit can be stored in a computer-readable storage medium. Based on this consideration, the substantial part, or the part that is contributed to the prior art of the technical solution of the present invention, or part or all of the technical solutions can be embodied in a software product. The computer software product is stored in a storage medium, and includes several instructions configured to enable a computer device (can be a personal computer, device, network device, and so on) to execute all or some of the steps of the method of each embodiment of the present invention. The storage medium includes a U disk, a mobile hard disk, a read-only memory (ROM, Read-Only Memory), a random access memory (RAM, Random Access Memory), a disk or a light disk, and other various mediums which can store program codes.

The above embodiments are merely intended to explain the technical solutions of the present invention, but not intended for limitation; although detail description has been made to the present invention with reference to the above embodiments, those ordinarily skilled in the art should understand that modifications to the technical solutions recited in the embodiments, or equivalent replacements to some of the technical features can still be made; these modifications and replacements do not make the substance of corresponding technical solutions depart from the spirit and scope of the technical solutions of each embodiment of the present invention.

The above contents are just preferred embodiments of the invention which is not for limiting the invention. Any improvements, equivalent replacements and modifications without departing from the spirit and principle of the invention should be deemed as contained within the protection scope of the invention.

What is claimed is:

1. A phase-error compensation method, wherein the method comprises:
utilizing a phase-shifting-profilometry measuring system to obtain fringe sequence charts;
based on Hilbert transform, transforming the fringe sequence charts from a space domain to a Hilbert transform domain;
based on least squares phase shift method, solving the phases of the fringe sequence charts in the space domain and the Hilbert transform domain respectively, and obtaining a phase chart in the space domain and a phase chart in the Hilbert transform domain;
averaging the phase chart in the space domain and the phase chart in the Hilbert transform domain to obtain an average phase, and utilizing the average phase to perform phase-error compensation.

2. The method of claim 1, wherein the fringe sequence charts obtained are expressed as follows:
$${I}_{n}^{C} = {[ A + B cos ( φ + {δ}_{n} ) ]}^{γ} = {B}_{0} + {\sum }_{k = 1}^{∞} [ {B}_{k} cos ( k {φ}_{n} ) ]$$
wherein, Iₙ^{C} represents an intensity of an n-th phase-shifting chart in a fringe sequence output by the phase-shifting-profilometry measuring system; A represents a background intensity of a fringe; B represents an adjusted intensity of the fringe; φ represents an actual phase adjusted by a surface under test; B₀ represents a DC component; Bₖ represents an intensity of a k-order harmonic; δₙ=2π(n−1)/N represents phase-shifting amount of the n-th phase-shifting chart; N represents the number of phase-shifting steps of the phase-shifting profilometry utilized by the phase-shifting-profilometry measuring system; φₙ=φ+δₙ represents an adjusted phase-shifting phase; γ represents a gamma coefficient of the system, the γ is a representation of the non-linear effect of the system.

3. The method of claim 2, wherein the step of based on Hilbert transform, transforming the phase-shifting fringe sequence charts from space domain to Hilbert transform domain comprises:
transforming the phase-shifting fringe sequence charts from the space domain to the Hilbert transform domain based on an equation
$${I}_{n}^{HC} = H ( {I}_{n}^{C} ) = - {\sum }_{k = 1}^{∞} [ {B}_{k} sin ( k {φ}_{n} ) ] ,$$
wherein H(g) represents the Hilbert transform; Iₙ^{HC} represents the intensity of the n-th phase-shifting chart in the fringe sequence output by the phase-shifting-profilometry measuring system after transformation.

4. The method of claim 3, wherein the step of based on least squares phase shift method, solving the phases of the fringe sequence charts in the space domain and the Hilbert transform domain respectively, and obtaining a phase chart in the space domain and a phase chart in the Hilbert transform domain comprises:
utilizing an equation
$${φ}^{C} = arctan [ \frac{- {\sum }_{n = 1}^{N} ( {I}_{n}^{C} sin {δ}_{n} )}{{\sum }_{n = 1}^{N} ( {I}_{n}^{C} cos {δ}_{n} )} ]$$
to solve the phase of the fringe sequence charts in the space domain;
utilizing an equation
$${φ}^{HC} = arctan [ \frac{{\sum }_{n = 1}^{N} ( {I}_{n}^{HC} cos {δ}_{n} )}{{\sum }_{n = 1}^{N} ( {I}_{n}^{HC} sin {δ}_{n} )} ]$$
to solve the phase of the fringe sequence charts in the Hilbert transform domain; wherein φ^{C} is a solved phase of the fringe sequence charts in the space domain; φ^{HC} is a solved phase of the fringe sequence charts in the Hilbert transform domain.

5. The method of claim 4, wherein the step of averaging the phase chart in the space domain and the phase chart in the Hilbert transform domain comprises:
Averaging a phase chart in the space domain and a phase chart in the Hilbert transform domain utilizing φ^{M}=½(φ^{C}+φ^{HC}), wherein φ^{M} is an averaged phase after an averaging step.

6. A phase-error compensation apparatus, wherein the device comprises:
an obtaining unit configured to utilize a phase-shifting-profilometry measuring system to obtain fringe sequence charts;
a transforming unit configured to transform the fringe sequence charts from space domain to Hilbert transform domain based on Hilbert transform;
a solving unit configured to solve phases of the fringe sequence charts in the space domain and Hilbert transform domain respectively based on least squares phase shift method, and obtain a phase chart in the space domain and a phase chart in The Hilbert transform domain;
a phase-error compensating unit configured to average the phase chart in the space domain and the phase chart in the Hilbert transform domain to obtain an average phase, and utilize the average phase to perform phase-error compensation.

7. The device of claim 6, wherein the fringe sequence charts obtained by the obtaining unit are expressed as follows:
$${I}_{n}^{C} = {[ A + B cos ( φ + {δ}_{n} ) ]}^{γ} = {B}_{0} + {\sum }_{k = 1}^{∞} [ {B}_{k} cos ( k {φ}_{n} ) ]$$
wherein, Iₙ^{C} represents an intensity of an n-th phase-shifting chart in a fringe sequence output by the phase-shifting-profilometry measuring system; A represents a background intensity of a fringe; B represents an adjusted intensity of a fringe; φ represents an actual phase adjusted by a surface under test; B₀ represents a DC component; Bₖ represents an intensity of a k-order harmonic; δₙ=2π (n−1)/N represents phase-shifting amount of the n-th phase-shifting chart; N represents the number of phase-shifting steps of the phase-shifting profilometry utilized by the phase-shifting-profilometry measuring system; φₙ=φ+δₙ represents an adjusted phase-shifting phase; γ represents a gamma coefficient of the system, the γ is a representation of a non-linear effect of the system.

8. The device of claim 7, wherein the transforming unit is specifically configured to:
transform the phase-shifting fringe sequence charts from the space domain to The Hilbert transform domain based on an equation
$${I}_{n}^{HC} = H ( {I}_{n}^{C} ) = - {\sum }_{k = 1}^{∞} [ {B}_{k} sin ( k {φ}_{n} ) ] ,$$
wherein H(g) represents Hilbert transform; Iₙ^{HC} represents an intensity of the n-th phase-shifting chart in the fringe sequence output by the phase-shifting-profilometry measuring system after transformation.

9. The device of claim 8, wherein the solving unit is specifically configured to:
utilize an equation
$${φ}^{C} = arctan [ \frac{- {\sum }_{n = 1}^{N} ( {I}_{n}^{C} sin {δ}_{n} )}{{\sum }_{n = 1}^{N} ( {I}_{n}^{C} cos {δ}_{n} )} ]$$
to solve the phase of the fringe sequence charts in the space domain;
utilizing an equation
$${φ}^{HC} = arctan [ \frac{{\sum }_{n = 1}^{N} ( {I}_{n}^{HC} cos {δ}_{n} )}{{\sum }_{n = 1}^{N} ( {I}_{n}^{HC} sin {δ}_{n} )} ]$$
to solve the phase of the fringe sequence charts in the Hilbert transform domain; wherein φ^{C} is a solved phase of the fringe sequence charts in the space domain; φ^{HC} is a solved phase of the fringe sequence charts in the Hilbert transform domain.

10. The device of claim 9, wherein the phase-error compensating unit is specifically configured to:
average the phase chart in the space domain and the phase chart in the Hilbert transform domain utilizing φ^{M}=½(φ^{C}+φ^{HC}), wherein φ^{M} is an averaged phase after an averaging step.
